(19) United States
(12) Patent Application Publication
(10) Pub. No.: US 2012/0247660 A1
(43) Pub. Date: Oct. 4, 2012

(54) METHOD FOR FORMING A SHOE PAD

(75) Inventors: Shun-Yen HOU, ZENG CHENG COUNTY (CN); Shih-Teng HUANG, ZENG CHENG COUNTY (CN)

(73) Assignee: GREAT SUNNY SPORTING GOODS CORPORATION, ZENG CHENG COUNTY (CN)

(21) Appl. No.: 13/074,100

(22) Filed: Mar. 29, 2011

(51) Int. Cl. B32B 37/02; B32B 38/10; B32B 37/14; B32B 38/04; A43D 999/00; B32B 37/10

(52) U.S. Cl. 156/253; 156/254

(57) ABSTRACT

A method for forming a shoe pad has steps of combining multiple colored material sheets to form a laminated layer, feeding the laminated layer between two rotating rollers having multiple corresponding protrusions and depressions to compress the laminated layer, cutting the laminated layer into two pad sheets with a cutter and forming a shoe pad from one of the pad sheets with a pressing process. Accordingly, a shoe pad in multiple colors and having a three dimensional shape is provided.

### BACKGROUND OF THE INVENTION

1. Field of the Invention

The present invention relates to a method, and more particularly to a method for forming a shoe pad in multiple colors and having a three dimensional shape.

2. Description of Related Art

A soft pad is always mounted in a shoe to increase the comfort of wearing the shoe. However, the conventional shoe pad has a single color, so the appearance of the conventional shoe pad is not attractive. In addition, the conventional shoe pad is a thin sheet and has a flat surface, such that the conventional shoe pad cannot provide any further additional function to a user and is not versatile in use.

To overcome the shortcomings, the present invention tends to provide a method of forming a shoe pad to mitigate or obviate the aforementioned problems.

### SUMMARY OF THE INVENTION

The main objective of the invention is to provide a method for forming a shoe pad in multiple colors and having a three dimensional shape.

The method for forming a shoe pad comprises steps of combining multiple colored material sheets to form a laminated layer, feeding the laminated layer between two rotating rollers having multiple corresponding protrusions and depressions to compress the laminated layer, cutting the laminated layer into two pad sheets with a cutter and forming a shoe pad from one of the pad sheets with a pressing process.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a method for forming a shoe pad in accordance with the present invention;

FIG. 2 is an enlarged side view showing the steps of compressing the laminated layer with two rollers and cutting the compressed laminated layer with a cutter;

FIG. 3 is a front view showing the step of compressing the laminated layer with two rollers;

FIG. 4 is an enlarged front view showing the step of compressing the laminated layer with two rollers;

FIG. 5 is a perspective view of a pad sheet made by the method in FIG. 1;

FIG. 6 is a perspective view of a shoe pad made by the method in FIG. 1; and

FIG. 7 is a perspective view of a shoe pad with multiple vents made by the method in FIG. 1.

### DETAILED DESCRIPTION OF PREFERRED EMBODIMENT

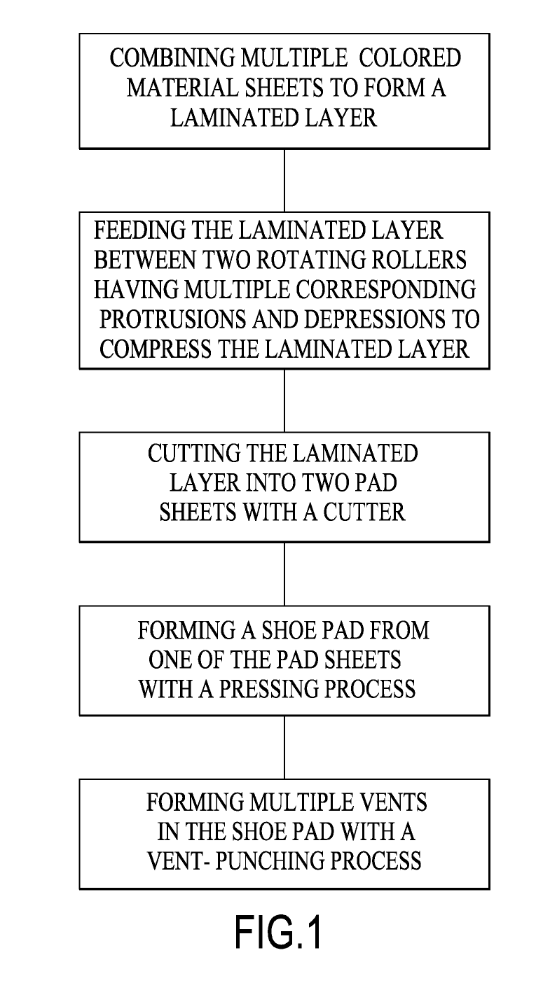

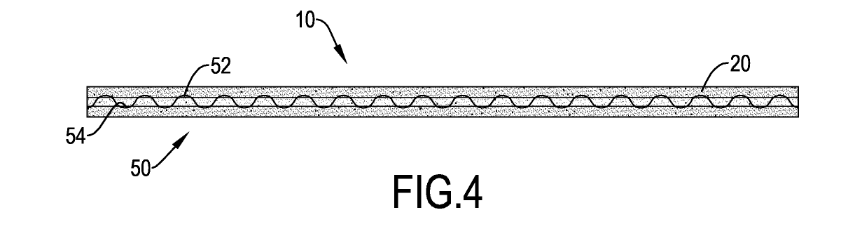

With reference to FIGS. 1 and 4, a method for forming a shoe pad in accordance with the present invention comprises steps of

1) Combining multiple colored material sheets 20 to form a laminated layer 10:

In the combining step, three material sheets 20 in different colors are combined to form the laminated layer 10. In the preferred embodiment, the top and bottom material sheets 20 may be in the same color and the middle material sheet 20 is in different color. Alternatively, the material sheets 20 have different three colors. In addition, each material sheet 20 is made of Ethylene-vinyl acetate (EVA). The material sheets 20 are combined with glue. In alternative embodiment, four or more colored material sheets 20 can be combined for forming a shoe pad in more than two colors.

2) Feeding the laminated layer 10 between two rotating rollers 30 having multiple corresponding protrusions 32 and depressions 34 to compress the laminated layer 10:

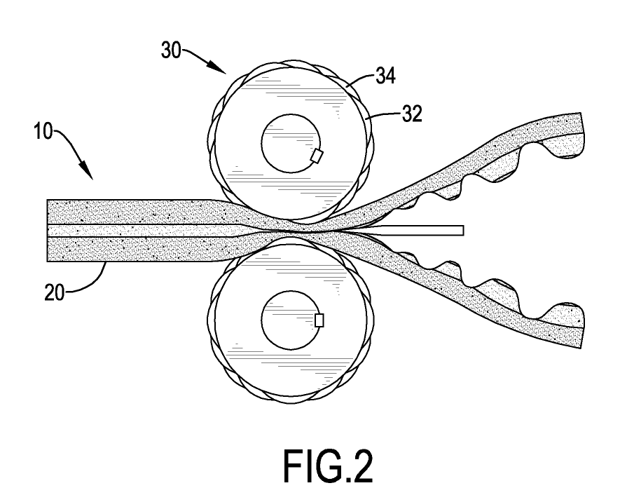

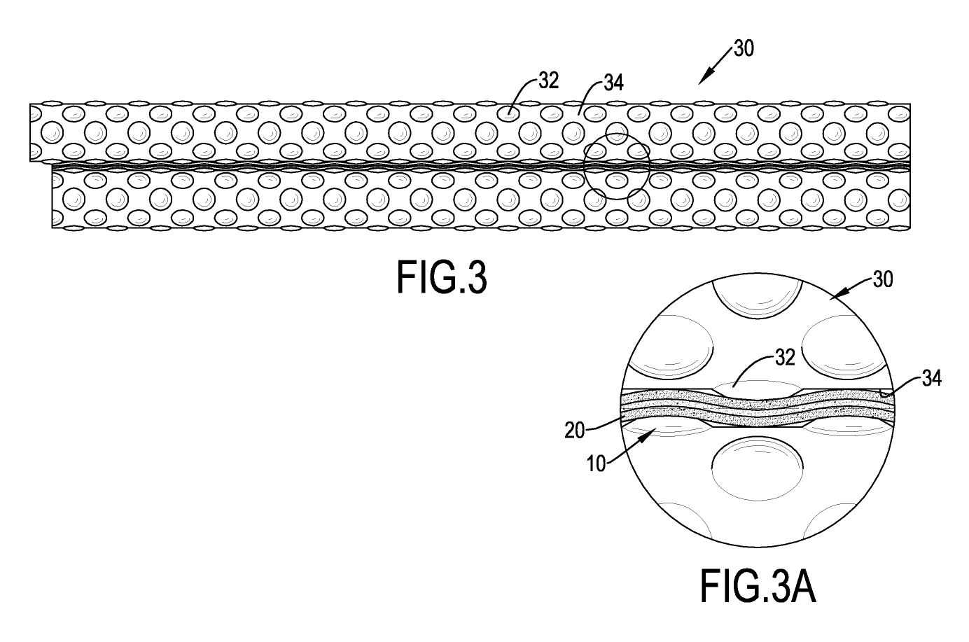

With reference to FIGS. 2, 3 and 3A, the laminated layer 10 is fed between and compressed by the two rollers 30. Each roller 30 has multiple protrusions 32 formed on and protruding from the outer surface of the roller 30 to form multiple depressions 34 between the protrusions 32. The protrusions 32 and depressions 34 of the rollers 30 correspond to each other, such that one of the protrusions 32 on one of the rollers 30 corresponds to one of the depressions 34 in the other roller 30. Preferably, each protrusion 32 has a curved surface or may be semi-spherical in cross section. When the laminated layer 10 is fed between the rollers 30, the laminated layer 10 will be compressed and deformed into a waved shape by the protrusions 32 and the depressions 34 on the rollers 30. With the rotation of the rollers 30, the laminated layer 10 can be moved and fed continuously, and the deformations of the laminated layer 10 at different positions are different because the different positions on the laminated layer 10 are compressed by different positions of the protrusions 32 on the rollers 30. The depressions 34 in the rollers 30 provide a space for the deformations of the laminated layer 10.

3) Cutting the laminated layer 10 into two pad sheets 50 with a cutter 40:

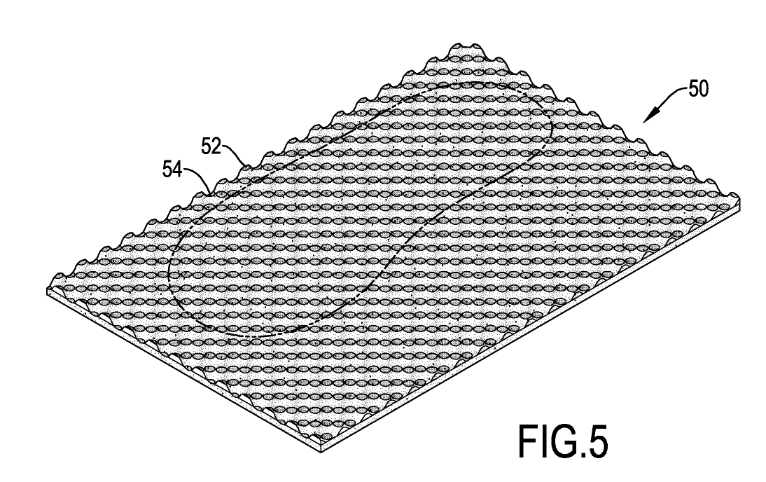

The cutter 40 is securely mounted between the rollers 30 and aligns with a central portion of the deformed laminated layer 10. When the laminated layer 10 is transported and fed by the rollers 30 and pass over the cutter 40, the cutter 40 will divide the compressed and deformed laminated layer 10 into two pad sheets 50 as shown in FIG. 5. Because the deformations of the laminated layer 10 at different positions are different, the cutter 40 can cut different positions of the deformed laminated layer 10 based on the shapes and positions of the protrusions 32 and the depressions 34 on the rollers 30 even while the cutter 40 is held at a fixed position. Therefore, one side of each pad sheet 50 has multiple protrusions 52 and depressions 54 formed thereon based on the shapes and positions of the protrusions 32 and the depressions 34 on the rollers 30 to form a three dimensional (3D) shape and effect.

In addition, because the laminated layer 10 is cut based on the shapes and positions of the protrusions 32 and depressions 34 on the rollers 30, the material sheets 20 are cut at different positions also based on the shapes and positions of the protrusions 32 and depressions 34. Therefore, the colors of the material sheets 20 can be presented on the protrusions 52 and depressions 54 formed on the pad sheet 50.

4) Forming a shoe pad from one of the pad sheets 50 with a pressing process:

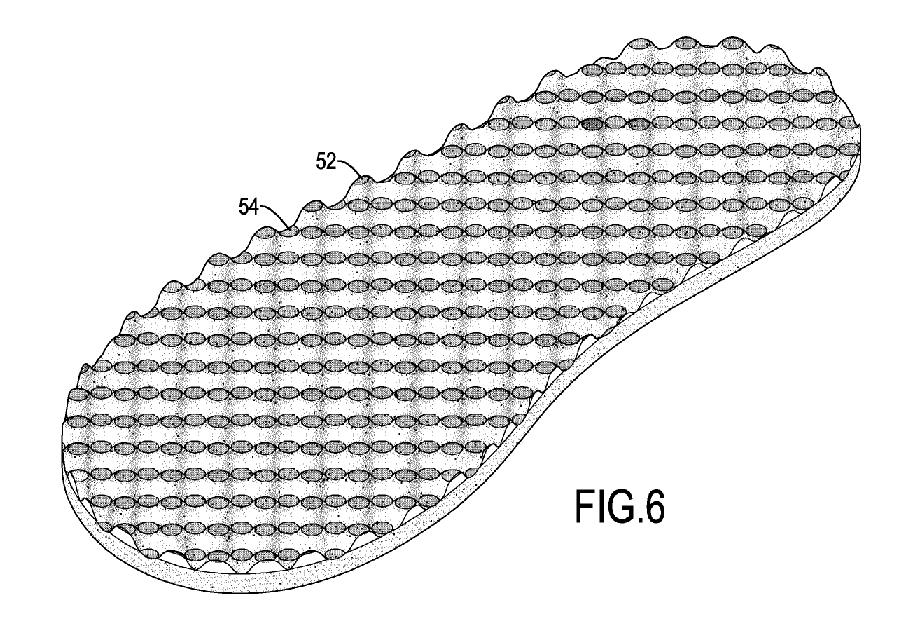

When a pad sheet 50 is applied with a pressing process with a mold, with reference to FIG. 6, a shoe pad having a shaped based on the mold can be formed. With the protrusions 52 and the depressions 54 formed on and the colors presented on the pad sheet 50, the shoe pad having a 3D shape and in multiple colors is provided.

5) Forming multiple vents 60 in the shoe pad with a vent-punching process:

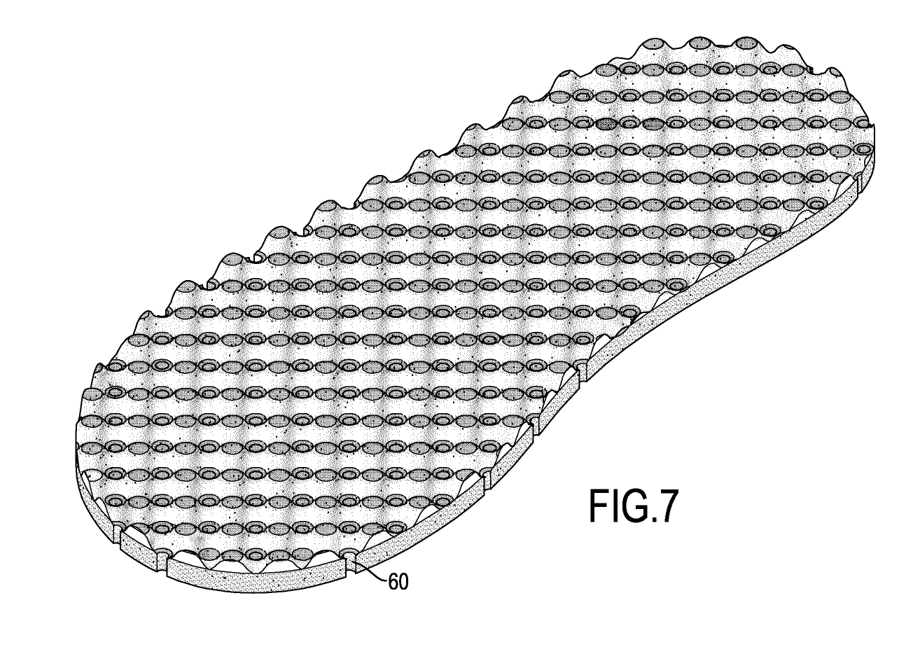

With reference to FIG. 7, the shoe pad can be further formed as a ventilation shoe pad having multiple vents 60 by being applied with a vent-punching process.

With such a method in accordance with the present invention, a shoe pad having a 3D shape and in multiple colors is provided, such that the aesthetic appearance and attractive effect to a user or customer can be improved. In addition, with the arrangement of the protrusions 52 and depressions 54 on the shoe pad, a ventilation effect of the shoe pad is accordingly enhanced and a massage effect can be provided to a user. Therefore, the use of the shoe pad is versatile and the comfort of wearing a shoe having the shoe pad in accordance with present invention is improved. Furthermore, different shapes and usages of pads, such as belts for backpacks can be formed with different molds to fit with different needs.

In addition, the hardnesses of the material sheets 20 may be different from each other to fit different needs of use and to improve the comfort while wearing, such that the use of the shoe pad is versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for forming a shoe pad comprising steps of
combining multiple colored material sheets to form a laminated layer;
feeding the laminated layer between two rotating rollers having multiple corresponding protrusions and depressions to compress the laminated layer;
cutting the laminated layer into two pad sheets with a cutter; and
forming a shoe pad from one of the pad sheets with a pressing process.

2. The method as claimed in claim 1 further comprising a step of forming multiple vents in the shoe pad with a vent-punching process.

3. The method as claimed in claim 2, wherein in the step of combining multiple colored material sheets, three material sheets in different colors are combined to form the laminated layer.

4. The method as claimed in claim 3, wherein each material sheet is made of Ethylene-vinyl acetate (EVA).

5. The method as claimed in claim 4, wherein the hardnesses of the material sheets are different from each other.

6. The method as claimed in claim 1, wherein each material sheet is made of Ethylene-vinyl acetate (EVA).

7. The method as claimed in claim 1, wherein the hardnesses of the material sheets are different from each other.
